(19) United States
(12) Patent Application Publication
(10) Pub. No.: US 2022/0327926 A1
(43) Pub. Date: Oct. 13, 2022

(54) Traffic Signal Out-Phase Green-Wave Mode Control Method

(71) Applicant: Weiping Meng, Flushing, NY (US)

(72) Inventor: Weiping Meng, Flushing, NY (US)

(21) Appl. No.: 17/642,700

(22) PCT Filed: Nov. 20, 2019
(86) PCT No.: PCT/CN2019/000223

§ 371 Date: Mar. 13, 2022

(30) Foreign Application Priority Data
Sep. 17, 2019 (CN) 201910873288.6

(51) Int. Cl. G08G 1/082

(52) U.S. Cl. CPC G08G 1/082

(57) ABSTRACT

A traffic signal control method for connecting different phases green signals between intersections, its key steps include: 1) get parameters of out-phase wave from mode instruction, 2) set out-phase interim period: start out-phase front wave, start out-phase post wave, or, end. Its advantages are providing basic algorithm and operations to solve and construct consecutive green signals for turning traffic between intersections, tool to implement for turning traffic to fast pass intersections, greatly lessen waiting time of turning traffic under current signal mode, improve efficiency of transportation.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### Technical Field and Prior Art

The present invention relates to a traffic control method, particularly to traffic signal connection method in out-phases between different intersections.

Currently traffic signal green-wave modes connecting straight phases traffic between different intersections solve no-stop pass traffic between intersections' straight phases. In reality, there are quite much amount of turning traffic demand, needing connection between different phases of different intersections. If different phases' green signals between intersections be connected, the need of turning traffic connection can be met, and traffic wait-time will be decreased.

### BRIEF SUMMARY OF THE INVENTION

It is an object of the present invention to realize the connection of different phase's green signals between intersections, decrease turning-traffic wait-time, improve the efficiency of traffic and signal control.

The present invention, with help of new signals' technologies including real-time moding, achieve the above object.

A method for connecting out-phase green signal wave between intersections in traffic signal network includes steps:

S1, Set RATIO as initial state with obtaining length and set-drive-time of every road-segment of a road-net;

S2, Set out-phase wave mode according to mode instruction: 1) get parameters of out-phase wave of the mode instruction; 2) set a signal interim period of the out-phase wave: start out-phase front wave, start out-phase post wave, or, end;

S3, Run the new mode after running out respective interim period of every intersection;

Said road-net is a group of mutually crossing roads, wherein its crossing points with their every directions controlled with traffic signals, called as intersections, divide the roads into road-segments, parallelly topologically;

Said RATIO is a traffic signal mode of road-nets, wherein all intersections' traffic signals run on ratio-rule synchronously, said ratio-rule bases on a period and ratios dividing the period into traffic signals controlling directions, said period is traffic signal green light times' sum of every directions controlled of an intersection;

Said out-phase wave is an abbreviation of traffic signal out-phase connection, means traffic-signal phase green lights connected between intersections include turning phases of left-turn phase and right-turn phase, is an out-phase mode of a green-wave; said green-wave, before, usually means that traffic signal green lights' phases connected between intersections only are straight phase, which runs on said time-offsets and said ratio-rule asynchronously, and orderly time-offsets make green light signal propagate between intersections directionally, from a source intersection to the intersection's adjacent one with bigger time-offset; Said source-intersection is an intersection of a green-wave set smallest time-offset comparing with the other intersections in a green-wave road-net;

Said interim period is sum of traffic signal green light set times in all directions controlled, is period remainder of switch time-offset of new mode comparing with current mode, in which traffic signal mode of an intersection changes from current mode to new mode; Said switch-time-offset is time-offset of two modes of new mode comparing with current mode, equals sum of current mode's complement and new mode's remainder; Said remainder is period remainder, =remainder (time-offset/period); Said complement is period complement, =period−remainder; Said time-off is a delay of an intersection period comparing with a mode source intersection period, related to cared distance and traffic time, is sum of all related road-segments time-offsets from source intersection to a downstream intersection of a green-wave;

Said set-drive-time is one of basic parameters of Lead green-wave, is drive time at set drive speed of a road-segment through the segment.

Another feature of the method for connecting out-phases' green signals between intersections, is that S2 includes: S21, Said parameters of out-phase wave include instruction, out-phase intersection and direction phase of the out-phase wave, the other intersection and direction phase of the road-segment of the out-phase wave, source intersection and direction phase of the out-phase wave, intersection coordinates or reference number of said road-net; the instruction includes start out-phase front wave, start out-phase post wave, or end out-phase wave;

Said out-phase intersection means such an intersection that the intersection's turn-phase green light is connected with the other intersection's straight phase green light of the road-segment; said out-phase front wave means out-phase wave wherein an out-phase intersection is a vehicle flow downstream intersection of the road-segment and set the downstream time-offset for the out-phase wave, the downstream time-offset is called as out-phase front time-offset; said out-phase post wave means out-phase wave wherein an out-phase intersection is a vehicle flow upstream intersection of the road-segment and set the upstream time-offset for the out-phase wave, the upstream time-offset is called as out-phase post time-offset.

Another feature of the method for connecting out-phases' green signals between intersections, is that S2 includes: S22.1, Said a signal interim period of start out-phase front wave include:

(S22.11) compute out-phase front time-offset using out-phase front drive-time, making ead out-phase wave;

(S22.12) optimize the out-phase front time-offsets: adjust the intersections' phase times ratio, phase order of the road-segment of the out-phase wave, to minimize the time-offset;

(S22.13) make, set interim period using the optimized time-offset;

Said out-phase front drive-time, front drive-time as its abbreviation, is set-drive-time of a road-segment where an out-phase front wave runs, with additional Lead time included, where the additional Lead time is caused by vehicle's braking to an out-phase intersection.

Another feature of the method for connecting out-phases' green signals between intersections, is that S2 includes: S22.11.1, Said front drive-time is set drive time of a road-segment where an out-phase front wave runs, with additional Lead time included, where the additional Lead time is caused by vehicle's braking to an out-phase intersection.

Another feature of the method for connecting out-phases' green signals between intersections, is that S2 includes: S22.2, Said a signal interim period of start out-phase post wave include:

(S22.21) compute out-phase post time-offset using out-phase post drive-time, making lead out-phase wave;

(S22.22) optimize the out-phase post time-offsets: adjust the intersections' phase times ratio, phase order of the road-segment of the out-phase wave, to minimize the time-offset;

(S22.23) make, set interim period using the optimized time-offset;

Said out-phase post drive-time, post drive-time as its abbreviation, is set-drive-time of the road-segment where an out-phase post wave runs, with additional Lead time included, where the additional Lead time is caused by vehicle's braking to turn and pass an out-phase intersection.

Another feature of the method for connecting out-phases' green signals between intersections, is that S2 includes: S22.21.1, Said out-phase post drive-time, post drive-time as its abbreviation, is set-drive-time of the road-segment where an out-phase post wave runs, with additional Lead time included, where the additional Lead time is caused by vehicle's braking to turn and pass an out-phase intersection.

Another feature of the method for connecting out-phases' green signals between intersections, is that S2 includes: S22.3, set interim start out-phase period include, optimizing the out-phase time-offsets: adjust the intersections' phase times ratio, phase order of the road-segment of the out-phase wave, to minimize the time-offset.

Another feature of the method for connecting out-phases' green signals between intersections, is that S2 includes: S22.12.1, Said optimized the out-phase front time-offsets include:

(a). reconfigure phase time and related ratios of connecting out-phases of the out-phase intersection;

(b). connecting phase time-offsets: phase time order time-offset that the downstream intersection's connecting phase is compared with its upstream connected phase in phase time order;

(c). common time-offset: connecting phase time-offsets−front drive time of the road-segment;

(d). optimize the time-offset: if common time-offset>=0, then postpone the source intersection period by the common time-offset, or advance the out-phase intersection period by the common time-offset, or, reconfigure phase time ratio according to the common time-offset; if common time-offset<0, then advance the source intersection period by the common time-offset, or postpone the out-phase intersection period by the common time-offset, or, reconfigure phase time ratio according to the common time-offset;

Said connecting out-phase time-offsets means that the downstream intersection's connecting phase is compared with its upstream connected phase in phase time order: earlier than, later than, or equal to its upstream one.

Another feature of the method for connecting out-phases' green signals between intersections, is that S2 includes: S22.22.1, Said optimized the out-phase post time-offsets include:

(a). reconfigure phase time and related ratio of the connecting out-phase of the out-phase intersection;

(b). connecting phase time-offsets: phase order time-offset that the downstream intersection's connecting phase is compared with its upstream connected phase in phase time order;

(c). common time-offset: connecting phase time-offsets−post drive time of the road-segment;

(d). optimize the time-offset: if common time-offset>=0, then postpone the out-phase source intersection period by the common time-offset, or advance the downstream intersection period by the common time-offset; if common time-offset<0, then advance the out-phase source intersection period by the common time-offset, or postpone the downstream intersection period by the common time-offset.

Another feature of the method for connecting out-phases' green signals between intersections, is that S2 includes: S22.3.1, Said optimized the out-phase time-offsets include, said connecting out-phase time-offsets means that the downstream intersection's connecting phase is compared with its upstream connected phase in phase time order: the earlier than its upstream need postponed, the later than need advanced;

Another feature of the method for connecting out-phases' green signals between intersections, is that S2 includes: S22.3.2, Said optimized the out-phase time-offsets include, for out-phase front wave, the common time-offset is the connecting phase's time-offset−front drive-time of the road-segment, or, for out-phase post wave, the common time-offset is the connecting phase's time-offset−post drive-time of the road-segment;

Another feature of the method for connecting out-phases' green signals between intersections, is that S2 includes: S22.3.3, Said optimized the out-phase time-offsets include, optimize out-phase time-offset, for the common time-offset>=0, postpone out-phase source intersection period by the common time-offset, or advance the downstream intersection period by the common time-offset; for common time-offset<0, advance the out-phase source intersection period by the common time-offset, or postpone the downstream intersection period by the common time-offset;

Another feature of the method for connecting out-phases' green signals between intersections, is that S2 includes: S22.4.1, Said set interim period of start out-phase front/post wave include, for interim period postponed by common time-offset, divide its period remainder into its controlled phases' signal times as post interim period, or, for interim period advanced by common time-offset, divide its period complement into its controlled phases' signal times as front interim period;

Another feature of the method for connecting out-phases' green signals between intersections, is that S2 includes: S22.4.2, Said set interim period of start out-phase front/post wave include, with switch time-offset's period remainder, divide the period remainder into its controlled phases' signal times as its interim period.

Another feature of the method for connecting out-phases' green signals between intersections, is that S2 includes: S22.4.3, Said set interim period of end out-phase front/post wave, for interim period postponed, use its period complement, or, for interim period advanced, use its period remainder.

Another feature of the method for connecting out-phases' green signals between intersections, is that includes:

S3, Run the new mode after running out the respective interim period of every intersection;

The advantages of the present invention are below: create a basic algorithm and operations that connects out-phase's green light between intersections, which provide basic algorithm and operations to solve and construct consecutive green signals for turning traffic between intersections, tool to implement for turning traffic to fast pass intersections, greatly lessen waiting time of turning traffic under current signal mode, improve efficiency of transportation.

### BRIEF DESCRIPTION OF THE DRAWINGS

FIG. 1 is a general view of an out-phase wave;

FIG. 2 is structure of a road-net with traffic signal control system and out-phase wave time-offsets setting and running;

FIG. 3 is a flowchart of out-phase wave control method;

FIG. 4 shows 4 schemes of the 2 embodiments of out-phase interim period setting and running;

### LIST OF REFERENCE NUMERAL UTILIZED IN THE DRAWING

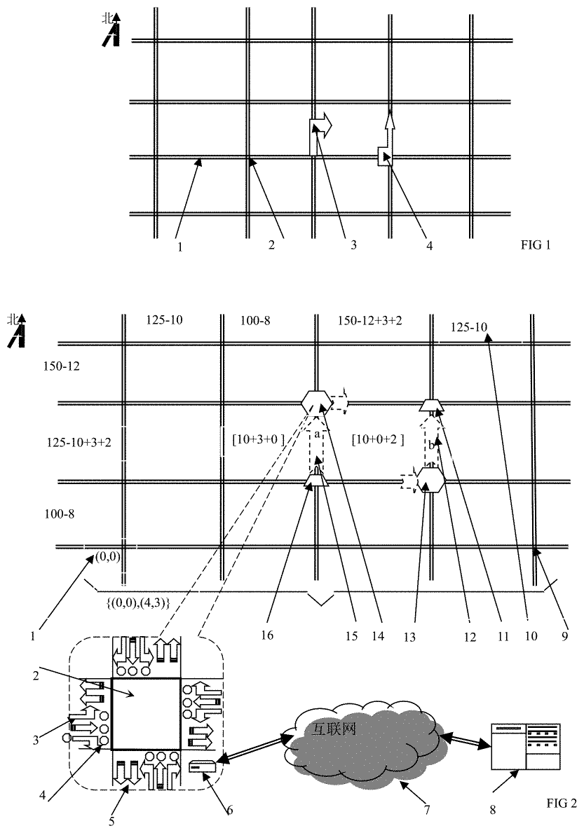

FIG. 1: 1—road-net, 2—intersection, 3—North traffic to turn right, 4—North traffic from turning left;

FIG. 2: 1—at lower-left corner, origin intersection's coordinates (0,0) of a road-net; wherein {(0,0), (4,3)} marked for the road-net; 2—intersection; 3—vehicle queue waiting for pass, including straight, left, right 3 phases vehicle queues; 4—traffic signals, including straight, left, right 3 phases signals; 5—vehicle queue passed; 6— traffic signals controller; 7—internet; 8—control system center; 9—roads and their crossings; 10—intersection spacing—set-drive-time denoted as “#−#”: unit, meter-second, set drive speed of 45 km/h, another label of “#−#+#+#”, 2 numbers # led by “+” are separately out-phase front additional time and out-phase post additional time; 11—out-phase post intersection (3,2), denoted as trapezoid; 12—out-phase post wave, in column road-segment (3,1), vehicle flow arrow pointing up-north, labeled by b, the label [#+0+#] is for [drive time+0+lead out-phase post additional time]; 13—out-phase intersection (3,1), denoted as hexagon, is a source intersection; 14—out-phase intersection (2,2), denoted as hexagon; 15—out-phase front wave, in column road-segment (2,1), vehicle flow arrow pointing up-north, labeled by a, the label [#+#+0] is for [drive time+lead out-phase front additional time+0]; 16—out-phase front intersection (2,1), denoted as trapezoid, is a source intersection;

### DETAILED DESCRIPTION OF THE INVENTION

### Description of the Preferred Embodiments, Industry Applications

A detailed description of embodiments of the invention in conjunction with the accompanying drawings:

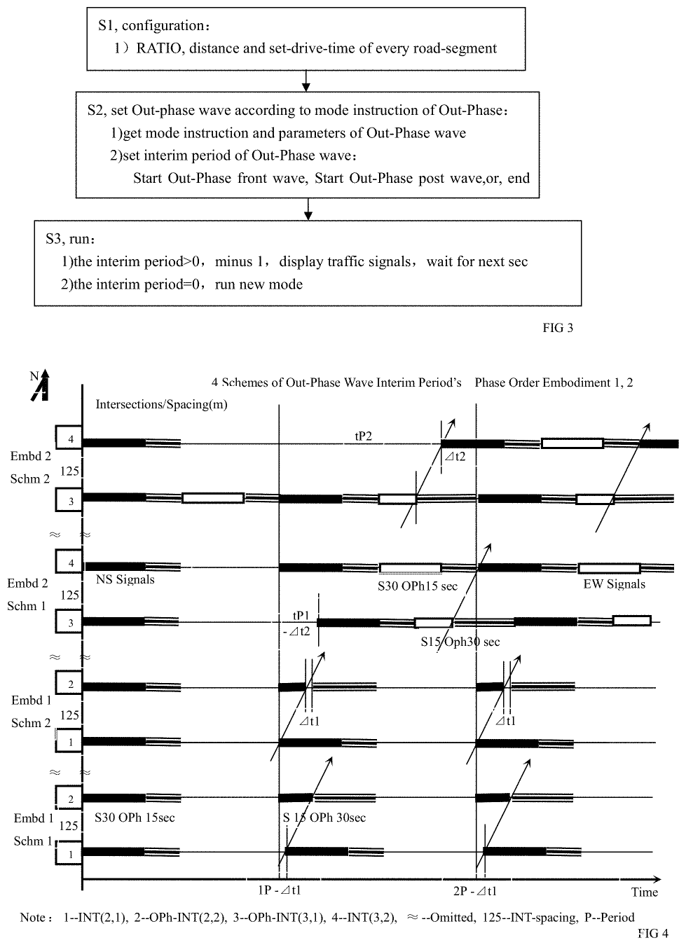

Create road-net system as shown in FIG. 2, intersection as label 2-2, vehicle flow as label 2-3,2-5 of intersections, are equipped with straight/left/right three phases signals as label 2-4, with a traffic signal machine as label 2-6 or with sensors, controlled through the communication network as label 2-7 from the control center as label 2-8 which execute the out-phase wave mode control methods and flowchart as shown in FIG. 3;

In FIG. 2, the features of a road-net include: coordinates(0,0) as label 2-1 of origin intersection at the lower left corner of road-net {(0,0), (4,3)} or {5,4}, which has a total of 20 intersections, 5 North-South col.-D-channels and 4 East-West row-D-channels, the set of the traffic-time of the col-D-channels Col. {5,3}{==}, for 15 corresponding North-South road-segments, the set of the traffic-time of the row-D-channels Row{4,4}{==}, for 16 corresponding East-West road-segments of the row-D-channels; the “#-#/#” as label 2-10 for length #-its set-drive-time # of each road-segment, unit: meter—second, wherein set-drive-time is calculated based on set-drive-speed=45 kilometers/hour, for an example, the length between intersection(3,2) and intersection(2,2) is 150 meters, its set-drive-time 12 secs, the length between intersection(2,2) and intersection(2,1) is 125 meters, its set-drive-time 10 secs;

In FIG. 2, said out-phase wave control method, include steps of,

S1, Set RATIO as initial state: (1) set north as initial signal direction of every intersection of a road-net, period=90 sec, direction phases time ratio=1, each direction phase time=45 sec., straight-turn(left/right) phases time ratio=2, straight phase time=30 sec., turn(left/right) phases time=15 sec., phase order: straight first then turn(out-phase); (2) obtain the length and set-drive-time, including out-phase traffic time, as label 2-12, 2-14, of every road-segment of the road-net of 5*4 intersections, 5 columns of channels, 4 rows of channels;

Set out-phase wave front wave interim period of embodiment 1:

S2, Set out-phase front wave label 2-15 interim period according to mode instruction:

1) get parameters of out-phase wave of the mode instruction; the mode instruction=start out-phase front wave, out-phase intersection coordinates=(2,2), vehicle flow direction=North, going to phase=right, out-phase front intersection coordinates=(2,1), vehicle flow direction=North, phase=straight, as source intersection of the out-phase wave, in road-segment (2,1) of columns;
2) set the out-phase front wave interim period:

(S22.11) compute out-phase front time-offset with front drive time,
(a) get front drive time 10 sec and front additional time 3 sec, as label 2-14;
(b) obtain out-phase front time-offset of the road-segment: 10+3=13 sec, the time-offsets {0,13} of intersections of road-segment (2,1), intersection(2,1)'s time-offset=0;

(S22.12) optimize the time-offset,
(a) reconfigure North's right phase as main time phase with same ratio as before for out-phase intersection(2,2), right 30 sec, straight 15 sec;
(b) connect phase time-offset: source intersection (2,1) North-straight phase order, advanced to intersection (2,2) North-right phase by 15 sec;
(c) out-phase time-offset: connecting phase time-offset—intersection(2,2)'s time-offset=15-13=2 sec(delay);
(d) optimize the time-offset: source intersection(2,1)'s time-offset=0 sec, out-phase intersection time-offset=2 sec(delay);

(S22.13) make the interim period with the optimized time-offset:
Add 2 sec to period of intersection (2,2);

Set out-phase wave post wave interim period of embodiment 1:

S2, Set out-phase post wave label 2-12 interim period according to mode instruction:

1) get parameters of out-phase wave of the mode instruction; the mode instruction=start out-phase post wave, out-phase intersection coordinates=(3,1), vehicle flow direction=East, going to phase=left, out-phase post intersection coordinates=(3,2), vehicle flow direction=North, phase=straight, in road-segment (3,1) of columns;
2) set the out-phase post wave interim period:

(S22.21) compute out-phase post time-offset with post drive time:
(a) get post drive time 10 sec and post additional time 2 sec, as label 2-12;
(b) obtain out-phase post time-offset of the road-segment:10+2=12 sec, the time-offsets {0,12} of intersections of road-segment (3,1), intersection(3,1)'s time-offset=0, as source intersection;

(S22.22) optimize the time-offset:
(a) reconfigure East's left phase as main time phase of the same ratio for out-phase intersection(3,1), as source intersection, left 30 sec, straight 15 sec;
(b) connect phase time-offset: downstream intersection (3,2) North-straight phase order, delayed to intersection (3,1) North-left phase by 30 sec;
(c) out-phase time-offset: connecting phase time-offset—intersection(3,2)'s time-offset=30-12=18 sec (advance);
(d) optimize the time-offset: source intersection(3,1)'s time-offset=18 sec(delay), the downstream intersection time-offset=0 sec;

(S22.23) make the interim period with the optimized time-offset;
make interim period of intersection (3,1) with the 18 sec: 18=9+9;

S3, Run the new mode after running out out-phase interim period traffic signals of every intersection: interim period>0, display traffic signals, wait next second, until the interim period=0, run new mode;

FIG. 4 shows 4 schemes(Schm) of the above described out-phase wave time set and running time sequence of Embodiments(Embd) 1,2, vertical axis is for pairs of intersections of connecting out-phase signals and their spacing, square is for intersection, one of the pairs of the intersections, intersection INT(2,1), intersection INT(2,2), intersection INT(3,1), intersection INT(3,2), their all spacing are 125 meters; horizontal axis is for time, labels of 1P,2P are signal period scales of 90 seconds, above the horizontal axis, there are combined lines of thick solid lines and triple lines stand for North-South signal phase time and phase shunt (i.e.,turn) structure, the ratio of straight-turn shunt phase times is 2 to 1, thick solid lines is for straight phase time 30 sec., triple lines for turn left/right phase time 15 sec.; the time spaces of two North-South signal phase time are East-West signal phase time; combined lines of thick hollow solid lines and triple lines stand for East-West signal phase time and phase shunt (i.e., turn) structure, the ratio of straight-turn shunt phase times is 2 to 1, thick hollow solid lines is for straight phase time 30 sec., triple lines for turn left/right phase time 15 sec.; arrow oblique lines pointing up-right are for vehicle flow directions, and shows that during the time spacing on the time axis vehicles flow through intersection spacing 125 meters arrive at the other one of the pair of intersections and just at the phase time pointed;

Scheme(Schm) 1 of Embodiment(Embd) 1, negative value—Δt1 is for delayed time of the period, means signal period of intersection (2,1) of the above setting is delayed 2 sec., after the straight phase of new period runs for 13 sec., vehicles flow reach intersection (2,2), just at time when the right phase green lights of the intersection turn on, wherein the right phase is configured as main phase of 30 sec., which realizes green light connection from straight phase to right phase; Scheme(Schm) 2 of Embodiment(Embd) 1, value Δt1 is for advanced and added time of the period with reconfiguration of main phase, means the right phase, set as main phase of 30 sec, of signal period of intersection (2,2) of the above setting is advanced with added 2 sec., after the straight phase of new period runs for 13 sec, vehicles flow reach intersection (2,2), just at time when its right phase green lights turn on, which realizes green light connection from straight phase to right phase, too;

Scheme(Schm) 1 of Embodiment(Embd) 2, negative value—Δ t2 is for delayed time of the period, means signal period of intersection (3,1) of the above setting is delayed 18 sec. with making interim period of tP1=18 sec., after left phase of new period runs for 12 sec., vehicles flow reach intersection (3,2), just at time instant when the straight phase green lights of the intersection turn on, wherein the left phase is configured as main phase of 30 sec., which realizes green light connection from left phase to straight phase; Scheme(Schm) 2 of Embodiment(Embd) 2, value Δ t2 is for the left phase advanced of the period with reconfiguration as main phase and occupying time of the previous period, means the left phase, set as main phase of 30 sec., of signal period of intersection (3,1) of the above setting is advanced, with advanced 18 sec. of intersection (3,2) making as its interim period tP2=P-18=90−18=72, after the intersection (3,1)'s left phase of new period runs for 12 sec., vehicles flow reach intersection (3,2), just at time when its straight phase green lights just turn on, which realizes green light connection from left phase to straight phase, too;

What is claimed as new and desired to be protected by Letters Patent is set forth in the following:

1. A method for connecting out-phase green signal wave between intersections in traffic signal network includes steps:
S1, Set RATIO as initial state with obtaining length and set-drive-time of every road-segment of a road-net;
S2, Set out-phase wave mode according to mode instruction: 1) get parameters of out-phase wave of the mode instruction; 2) set a signal interim period of the out-phase wave: start out-phase front wave, start out-phase post wave, or, end;
S3, Run the new mode after running out respective interim period of every intersection;
Said road-net is a group of mutually crossing roads, wherein its crossing points with their every directions controlled with traffic signals, called as intersections, divide the roads into road-segments, parallelly topologically;
Said RATIO is a traffic signal mode of road-nets, wherein all intersections' traffic signals run on ratio-rule synchronously, said ratio-rule bases on a period and ratios dividing the period into traffic signals controlling directions, said period is traffic signal green light times' sum of every directions controlled of an intersection;
Said out-phase wave is an abbreviation of traffic signal out-phase connection, means traffic-signal phase green lights connected between intersections include turning phases of left-turn phase and right-turn phase, is an out-phase mode of a green-wave; said green-wave, before, usually means that traffic signal green lights' phases connected between intersections only are straight phase, which runs on said time-offsets and said ratio-rule asynchronously, and orderly time-offsets make green light signal propagate between intersections directionally, from a source intersection to the intersection's adjacent one with bigger time-offset; Said source-intersection is an intersection of a green-wave set smallest time-offset comparing with the other intersections in a green-wave road-net;
Said interim period is sum of traffic signal green light set times in all directions controlled, is period remainder of switch time-offset of new mode comparing with current mode, in which traffic signal mode of an intersection changes from current mode to new mode; Said switch-time-offset is time-offset of two modes of new mode comparing with current mode, equals sum of current mode's complement and new mode's remainder; Said remainder is period remainder, =remainder (time-offset/period); Said complement is period complement, =period−remainder; Said time-off is a delay of an intersection period comparing with a mode source intersection period, related to cared distance and traffic time, is sum of all related road-segments time-offsets from source intersection to a downstream intersection of a green-wave;
Said set-drive-time is one of basic parameters of Lead green-wave, is drive time at set drive speed of a road-segment through the segment.

2. A method for connecting out-phase green signals between intersections as in claim 1, wherein step S2 includes: S21, Said parameters of out-phase wave include instruction, out-phase intersection and direction phase of the out-phase wave, the other intersection and direction phase of the road-segment of the out-phase wave, source intersection and direction phase of the out-phase wave, intersection coordinates or reference number of said road-net; the instruction includes start out-phase front wave, start out-phase post wave, or end out-phase wave;
Said out-phase intersection means such an intersection that the intersection's turn-phase green light is connected with the other intersection's straight phase green light of the road-segment; said out-phase front wave means out-phase wave wherein an out-phase intersection is a vehicle flow downstream intersection of the road-segment and set the downstream time-offset for the out-phase wave, the downstream time-offset is called as out-phase front time-offset; said out-phase post wave means out-phase wave wherein an out-phase intersection is a vehicle flow upstream intersection of the road-segment and set the upstream time-offset for the out-phase wave, the upstream time-offset is called as out-phase post time-offset

3. A method for connecting out-phase green signals between intersections as in claim 1, wherein step S2 includes: S22.1, Said a signal interim period of start out-phase front wave include:
(S22.11) compute out-phase front time-offset using out-phase front drive-time, making Lead out-phase wave;
(S22.12) optimize the out-phase front time-offsets: adjust the intersections' phase times ratio, phase order of the road-segment of the out-phase wave, to minimize the time-offset;
(S22.13) make, set interim period using the optimized time-offset;
Said out-phase front drive-time, front drive-time as its abbreviation, is set-drive-time of a road-segment where an out-phase front wave runs, with additional Lead time included, where the additional Lead time is caused by vehicle's braking to an out-phase intersection.

4. A method for connecting out-phase green signals between intersections as in claim 1, wherein step S2 includes: S22.11.1, Said front drive-time is set drive time of a road-segment where an out-phase front wave runs, with additional Lead time included, where the additional Lead time is caused by vehicle's braking to an out-phase intersection.

5. A method for connecting out-phase green signals between intersections as in claim 1, wherein step S2 includes: S22.2, Said a signal interim period of start out-phase post wave include:
(S22.21) compute out-phase post time-offset using out-phase post drive-time, making lead out-phase wave;
(S22.22) optimize the out-phase post time-offsets: adjust the intersections' phase times ratio, phase order of the road-segment of the out-phase wave, to minimize the time-offset;
(S22.23) make, set interim period using the optimized time-offset;
Said out-phase post drive-time, post drive-time as its abbreviation, is set-drive-time of the road-segment where an out-phase post wave runs, with additional Lead time included, where the additional Lead time is caused by vehicle's braking to turn and pass an out-phase intersection.

6. A method for connecting out-phase green signals between intersections as in claim 1, wherein step S2 includes: S22.21.1, Said post drive-time as its abbreviation, is set-drive-time of a road-segment where an out-phase post wave runs, with additional Lead time included, where the additional Lead time is caused by vehicle's braking to turn and pass an out-phase intersection.

7. A method for connecting out-phase green signals between intersections as in claim 1, wherein step S2 includes: S22.3, set interim start out-phase period include, optimizing the out-phase time-offsets: adjust the intersections' phase times ratio, phase order of the road-segment of the out-phase wave, to minimize the time-offset.

8. A method for connecting out-phase green signals between intersections as in claim 1, wherein step S2 includes: S22.12.1, Said optimized the out-phase front time-offsets include:
(a). reconfigure phase time and related ratios of connecting out-phases of the out-phase intersection;
(b). connecting phase time-offsets: phase time order time-offset that the downstream intersection's connecting phase is compared with its upstream connected phase in phase time order;
(c). common time-offset: connecting phase time-offsets−front drive time of the road-segment;
(d). optimize the time-offset: if common time-offset>=0, then postpone the source intersection period by the common time-offset, or advance the out-phase intersection period by the common time-offset, or, reconfigure phase time ratio according to the common time-offset; if common time-offset<0, then advance the source intersection period by the common time-offset, or postpone the out-phase intersection period by the common time-offset, or, reconfigure phase time ratio according to the common time-offset;
Said connecting out-phase time-offsets means that the downstream intersection's connecting phase is compared with its upstream connected phase in phase time order: earlier than, later than, or equal to its upstream one.

9. A method for connecting out-phase green signals between intersections as in claim 1, wherein step S2 includes: S22.22.1, Said optimized the out-phase post time-offsets include:
(a). reconfigure phase time and related ratio of the connecting out-phase of the out-phase intersection;
(b). connecting phase time-offsets: phase order time-offset that the downstream intersection's connecting phase is compared with its upstream connected phase in phase time order;
(c). common time-offset: connecting phase time-offsets−post drive time of the road-segment;
(d). optimize the time-offset: if common time-offset>=0, then postpone the out-phase source intersection period by the common time-offset, or advance the downstream intersection period by the common time-offset; if common time-offset<0, then advance the out-phase source intersection period by the common time-offset, or postpone the downstream intersection period by the common time-offset.

10. A method for connecting out-phase green signals between intersections as in claim 1, wherein step S2 includes: S22.3.1, Said optimized the out-phase time-offsets include, said connecting out-phase time-offsets means that the downstream intersection's connecting phase is compared with its upstream connected phase in phase time order: the earlier than its upstream need postponed, the later than need advanced.

11. A method for connecting out-phase green signals between intersections as in claim 1, wherein step S2 includes: S22.3.2, Said optimized the out-phase time-offsets include, for out-phase front wave, the common time-offset is the connecting phase's time-offset−front drive-time of the road-segment, or, for out-phase post wave, the common time-offset is the connecting phase's time-offset−post drive-time of the road-segment.

12. A method for connecting out-phase green signals between intersections as in claim 1, wherein step S2 includes: S22.3.3, Said optimized the out-phase time-offsets include, optimize out-phase time-offset, for the common time-offset>=0, postpone out-phase source intersection period by the common time-offset, or advance the downstream intersection period by the common time-offset; for common time-offset<0, advance the out-phase source intersection period by the common time-offset, or postpone the downstream intersection period by the common time-offset.

13. A method for connecting out-phase green signals between intersections as in claim 1, wherein step S2 includes: S22.4.1, Said set interim period of start out-phase front/post wave include, for interim period postponed by common time-offset, divide its period remainder into its controlled phases' signal times as postponed interim period, or, for interim period advanced by common time-offset, divide its period complement into its controlled phases' signal times as advanced interim period.

14. A method for connecting out-phase green signals between intersections as in claim 1, wherein step S2 includes: S22.4.2, Said set interim period of start out-phase front/post wave include, with switch time-offset's period remainder, divide the period remainder into its controlled phases' signal times as its interim period.

15. A method for connecting out-phase green signals between intersections as in claim 1, wherein step S2 includes: S22.4.3, Said set interim period of end out-phase front/post wave, for interim period postponed, use its period complement, or, for interim period advanced, use its period remainder.

16. A method for connecting out-phase green signals between intersections as in claim 1, wherein step S2 includes: S3, Run the new mode after running out the respective interim period of every intersection.
